(19) United States
(12) Patent Application Publication
(10) Pub. No.: US 2011/0153619 A1
(43) Pub. Date: Jun. 23, 2011

(54) PERSONALIZED CONTENT LINKS

(75) Inventors: BERNADETTE A. CARTER, CARY, NC (US); MICHAEL D. FACEMIRE, PITTSBORO, NC (US); MICHAEL C. WANDERSKI, DURHAM, NC (US)

(73) Assignee: INTERNATIONAL BUSINESS MACHINES CORPORATION, ARMONK, NY (US)

(21) Appl. No.: 12/645,052

(22) Filed: Dec. 22, 2009

(51) Int. Cl. G06F 17/30

(52) U.S. Cl. 707/748; 707/754; 707/E17.116

(57) ABSTRACT

Content with personalized content links are published at a server. The content and specified content characteristics of the content are received at the server. In addition, potential reader's personalization indicators are received by the server. The content is linked with the specified content characteristics and the potential reader's personalization indicators. The content is then published at the server.

### BACKGROUND

The present invention relates, in general, to messaging, and more specifically, to personalized dissemination of document content.

Documents may be attached to email and/or files may be transferred in instant messaging systems as a way to share content. As more content is stored in server-managed repositories, such as, online data stores, it has also become more common to share referenced content instead of the actual content (e.g. rather than attaching a file to an email, a link to a referenced file is transferred) to help reduce inbox clutter, manage quotas, eliminate version anxiety, etc.

The combination of online storage (i.e. referenced content), social networks and sharing, and collaborative distribution applications/systems like email and instant messaging integrated as a common platform for collaboration, introduces an opportunity for improved scenarios for publishing documents or content to a community. Each person in the community brings a different background and experience. While a document may be relevant to everybody in a community, that does not mean that every section is relevant to each person. When the membership of the community is large, it would not be realistic to expect a content author to determine which sections of the document will be relevant to each member in the community.

### BRIEF SUMMARY

According to one embodiment of the present invention, content with personalized content links are published at a server. The content and specified content characteristics of the content are received at the server. In addition, potential reader's personalization indicators are received by the server. The content is linked with the specified content characteristics and the potential reader's personalization indicators, and the content is published at the server.

According to one embodiment of the present invention, a computer system publishes content with personalized content links. A processor is programmed to receive content and specified content characteristics of the content. In addition, potential reader's personalization indicators are received. The content is linked with the specified content characteristics and the potential reader's personalization indicators. The content is then published.

According to one embodiment of the present invention, a computer program product publishes content with personalized content links. The computer program product comprises a computer readable storage medium having computer readable program code embodied therewith. The computer readable program code is configured to receive content, specified content characteristics of the content, and said potential reader's personalization indicators. The content is linked with the specified content characteristics and the potential reader's personalization indicators. The content is then published.

### BRIEF DESCRIPTION OF THE SEVERAL VIEWS OF THE DRAWINGS

FIG. 1 is a hardware diagram that may implement an embodiment of the invention;

FIG. 2 is a flow chart illustrating the actions of an author to utilize an embodiment of the present invention;

FIG. 3 is a flow chart illustrating an embodiment of the present invention in relation to a reader; and

FIG. 4 illustrates possible sources for obtaining personalization data.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

A computer readable signal medium may include a propagated data signal with computer-usable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that can contain, store, communicate, propagate, or transport a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and/or partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

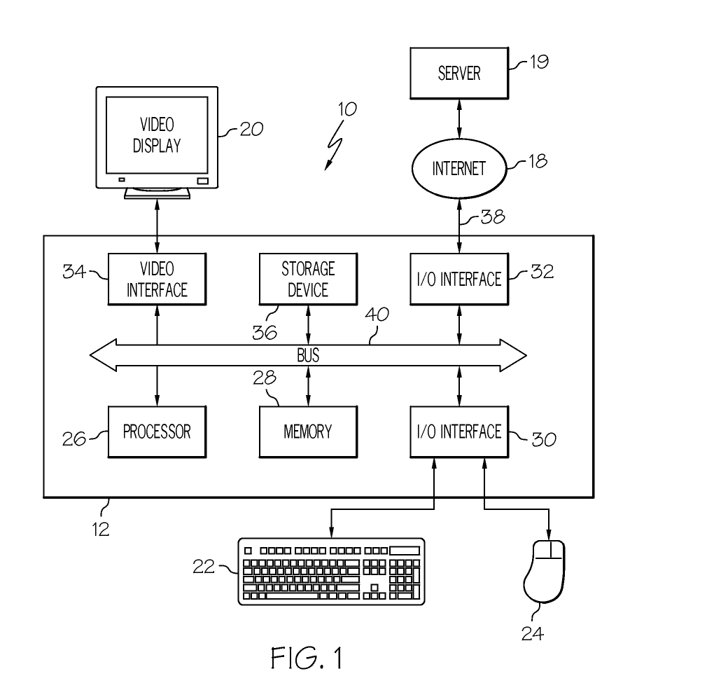

FIG. 1 is one example of a computer system 10 suitable for executing computer software for creating and distributing personalized content in accordance with the techniques described. Other processing devices which are suitable for executing the software can be a wireless telephone, personal assistant device (PDA), portable computer, smart remote control device, or any other processing devices that can execute such software.

The computer system 10 is of a type that executes under a suitable operating system installed on the computer system 10, and may be thought of as comprising software code for efficiently controlling presence awareness through bartering and policy control in a peer-to-peer messaging system. The components of the computer system 10 include a computer 12, a keyboard 22, mouse 24, and a video display 20. The computer 12 includes a processor 26, a memory 28, input/output (I/O) interfaces 30 and 32, a video interface 34, and a storage device 36.

The processor 26 is a central processing unit (CPU) that executes the operating system and the computer software executing under the operating system. The memory 28 includes random access memory (RAM) and read-only memory (ROM), and is used under direction of the processor 26.

The video interface 34 is connected to a video display 20 and provides video signals for display thereon. User input to operate the computer 12 is provided from the keyboard 22 and mouse 24. The storage device 36 can include a disk drive or any other suitable storage medium, as discussed above. Each of the components of the computer 12 is connected to an internal bus 40 that includes data, address, and control buses, to allow components of the computer 12 to communicate with each other via the bus 40. The computer system 10 can be connected to one or more other similar computers via an input/output (I/O) interface 32 using a communication channel 38 to a network, represented as the Internet 18. One or more servers 19 may be connected to the computer 12 via a network, such as, the Internet 18. The servers 19 may comprise the same physical arrangement as the computer 12 and may be co-located with or a part of the computer 12.

The computer software may be recorded on a computer readable storage medium, in which case, the computer software program is accessed by the computer system 10 from the storage device 36. Alternatively, the computer software can be accessed directly from the Internet 18 by the computer 12. In either case, a user can interact with the computer system 10 using the keyboard 22 and mouse 24 to operate the programmed computer software executing on the computer 12.

An embodiment of the present invention analyzes content based on a reader profile to provide a personalized content reading experience. The reader profile of the user may be constructed by gathering data from sources selected by the user, such as organization charts, social networks, previous communication (i.e. email and chats), social bookmark systems, or any other area that might provide additional insight into the user and his/her interests. Additionally, the profile may be constructed by the reader or by the reader allowing access to other systems to build the right relationships to determine the right user profile. Personalized links are created to bring to the forefront, sections of a document that are likely to be of greatest interest to the reader. As will be described in greater detail, links to subsections in the document will be determined and created when the user accesses the content. Link creation will be based on the reader profile. Consequently, the links may change over time as a user's role or interests change.

An embodiment of the present invention would be applicable, for example, to a software architectural design document. This type of document may be a presentation with multiple slides, each dedicated to a specific topic related to the overall design. Such a document may be distributed widely before an official review meeting, while only a relatively small part of the overall presentation is actually pertinent to each individual that receives it. Because of this, people on the distribution list may waste time reviewing content that is irrelevant to them in the document. Content links based on areas of focus for an individual can be determined by how the topics of each slide have been identified by the author. Additionally, the system can dynamically determine areas of focus based on, for example, keywords, and matching that criteria to the social profile and particular context when the document is being reviewed. In addition to written media, audio and video media may be used, for example, music or video scenarios where the user may want a selection of pictures or other music/video attributes. While the present invention is equally applicable to written, audio, and video, the description herein will refer to written materials for the sake of simplicity and clarity.

In an embodiment of the present invention, the author may provide fine grained access control based on user characteristics. The author may lock specific parts of the document if a user has specific, deterministic characteristics such as a “manager flag” in a company corporate directory system. On the other hand, the author may specify calling out certain sections to users with a specific set of characteristics. The content author may be as active or passive in content link generation and access control as he/she wishes.

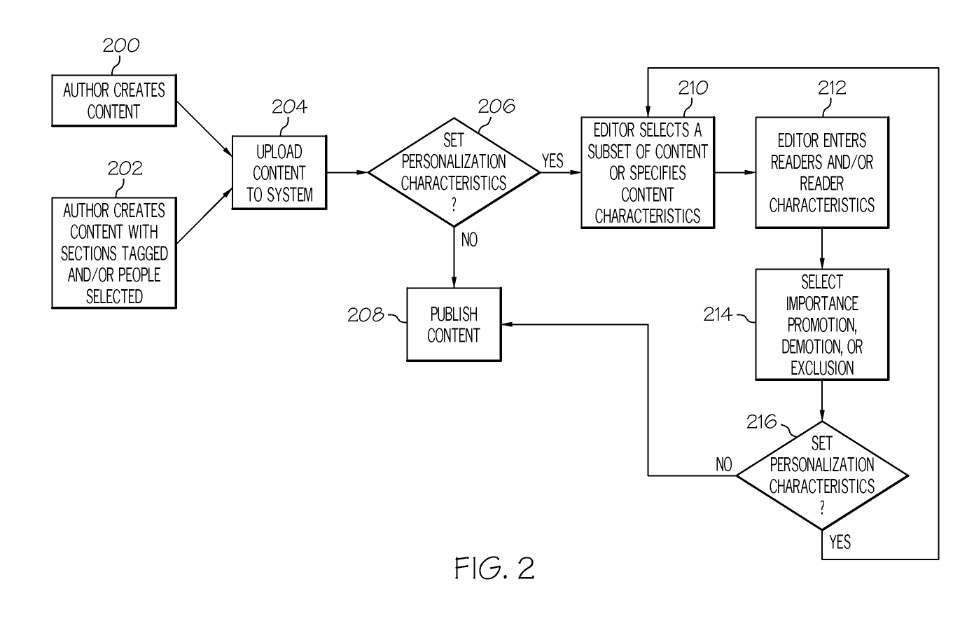

Referring to FIG. 2, a flowchart for publishing content in accordance with an embodiment of the present invention is illustrated. The author creates content (i.e., prepares a written, audio, or video document) at block 200. In addition to standard content creation at block 200, an alternative embodiment may allow the author to create content at block 202 with sections and/or users tagged. Specific readers and/or reader characteristics for sections of content may be indicated via an installed plug-in or accessed from a content creation application (for example, a word processor).

At block 204, the content is uploaded to a distribution system (web page, email, social network, etc.).

At decision block 206, it is determined whether any personalization characteristics are to be set. If the response is no, the content is published at block 208.

If the response to decision block 206 is yes, the editor selects a subset of content or specifies content characteristics at block 210. The author may select content by adding text (for example, entering keywords (aka tags), structure characteristics, or complex queries) or using a graphical process (for example, using a mouse to select a content section).

The process then proceeds to block 212 where the editor/author (an editor may be any user or group who has “edit” rights on the document, including the author) may also specify readers by selecting individuals or a group. In addition, the system may allow an editor to specify any potential reader or limit reader selection to entities on a previously determined publish list, which is a list of users to be notified when the content is published. At block 212, the author/editor may also specify reader characteristics, such as, for example, expertise, interests, or interaction topics (recent IM chat session, email, phone conversations, interactions with people who have expertise in the area etc.).

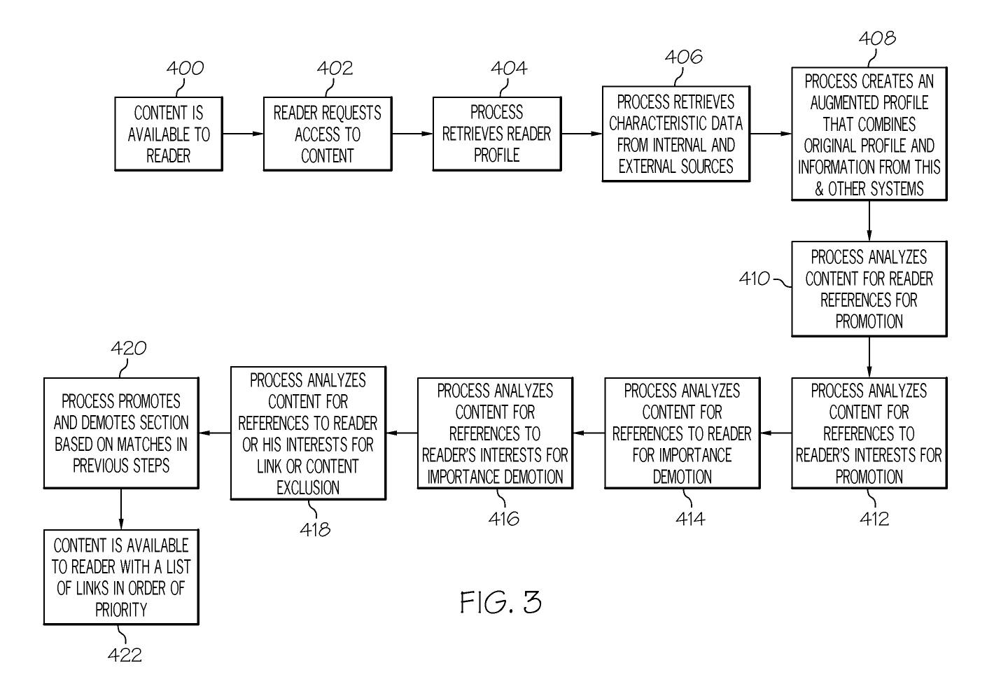

At block 214, the editor may designate the content selected at block 210 to have its level of importance promoted (personalized content link importance increased and moved up in a link list, as will be subsequently described below with reference to FIG. 3), demoted (personalized content link moved down in a link list or excluded at the link or content level. Exclusion means that a personalized link should not be created for users who meet these characteristics. In other words, ensure that no link is created to this section for users with characteristics matching those from block 212.

At decision block 216, it is determined whether there are more personalization characteristics to be set. If the response to decision block 216 is no, the process proceeds to block 208 where the content is published. If the response to decision block 216 is yes, the process returns to block 210 for another iteration. In addition, after the content has been published, an editor may return to blocks 210, 212, and 214 to modify the importance promotion/demotion/exclusion selections at any time. If a modification is performed, then the personalized links provided to readers initially may also change depending upon the modifications. If modification occurs, the reader will be notified of the change during the next content access.

Referring to FIG. 3, a flowchart for accessing content in accordance with an embodiment of the present invention is illustrated. At block 400, content is available to the reader, such as by email, a content server, etc. The reader then requests access to the content at block 402.

At block 404, the process retrieves the reader's profile which may be stored locally, on an external system, or be the result of combining profiles from multiple systems. The base user profile may comprise, but not be limited to, manually entered topics, people, or characteristics to promote/demote/or exclude. It may also comprise a query based selection process. The user may be more or less interested in content created or edited by specific people or people with whom a specific relationship or interaction pattern exists. The process may also take into consideration the time of the editor's edit and the state of the reader's relationship with the editor at the time of content modification, as well as the state of the editor's relationship with the content subject matter. Metadata, from the content, and settings from the base user profile, may be used to scour internal and external systems for references or interactions with the content tags or actual editors. Actions taken by other people in the user's social network with similar content may also be given consideration.

At block 406, related characteristic data from internal and external sources is retrieved. Content that is most actively searched for may be impacted by metadata associated with the content. For example, if the content has already been tagged with the word “legal” and “patent”, then for social networks, the system will do more in depth analysis for relationships and actions with content or people who are in the legal profession and/or are related to “patent” matters. Characteristics may also be obtained from the device the user is leveraging to access the content, such as, but not limited to the corresponding workstation or mobile device. For each external system, information such as, interests, job type, position in organization hierarchy, topics of interactions with author or editors, relationships with other knowledge experts of this content area may be retrieved.

At block 408, an augmented reader profile is created. The augmented reader profile is created by combining the original profile from block 404 and characteristic data from block 406. Thus, the reader profile of block 408 may be specialized for the current content access since it is an augmented version of the base profile that is the result of being influenced by the characteristics extracted from the previous state, such as but not limited to, the user's state (status in social systems, type and contextual information from a content access device, and state of the current environment) in systems such as social networks and any interactions occurring around the time of the current content access request.

The process then proceeds to analyze content for reader references for promotion at block 410. The system reads through the content and creates potential links whenever the reader is referenced in metadata for a section of content. Each such reference may increase a content score by a level of influence. In an embodiment of the invention, the editor may be allowed to provide a level of influence in order to indicate an increased/decreased level of impact. In another embodiment the content score may simply be increased for every occurrence of a reference to the reader.

At block 412, the process then proceeds to analyze content for references to the reader's interests for promotion. Similar to block 410, the system reads through the content to compare/contrast metadata to find references to characteristics of the reader per the reader profile.

The process then proceeds to analyze content for references to the reader for importance demotion at block 414 and references to the reader's interests for importance demotion at block 416. Thus, the absence of any references to the reader or any references to the interests of the reader would indicate lower levels of importance to the reader. At block 418, the content is checked for references to the reader or his interests for link or content exclusion.

At block 420, the process promotes and demotes sections of the content based upon matches in the previous blocks 410-418. At block 422, the content is made available to the reader with a list of links in order of priority (ascending or descending, depending upon the user's preference) to the reader.

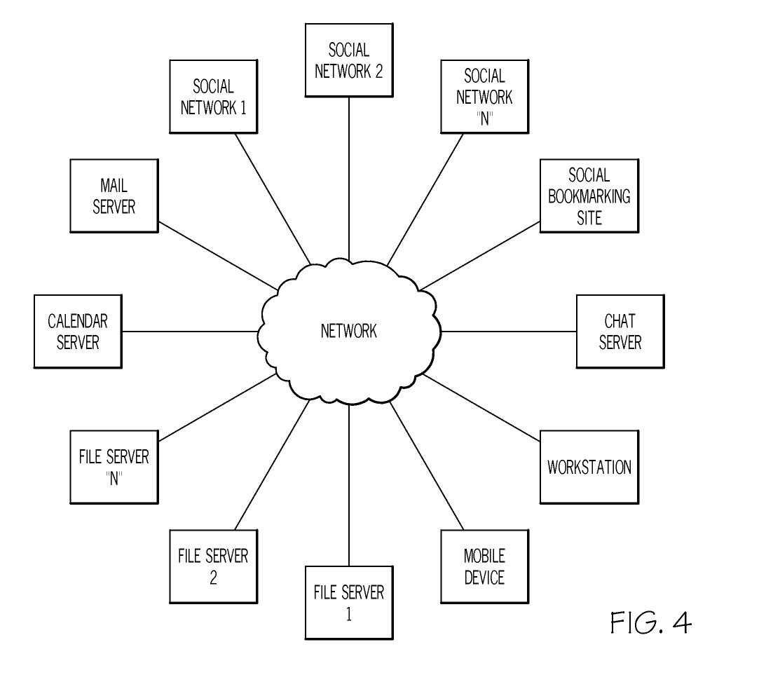

As previously described above, document analysis comprises rating areas of the document with respect to perceived relevance for the user by comparing the content to the role and interests of the user. Therefore, the user profile/characteristics need to be prepared with as much detail as possible. As illustrated in FIG. 4, user data may be acquired though a network by retrieving data from a plurality of internal and external system sources such as profiles, community memberships, place in organization and corresponding role, social networks, social bookmark systems, previous communication, and any other tool that may provide additional insight. The system will compare and contrast sections of the document to the perceived interests and role of the user. In addition, further insight may be gained by considering prior interactions that may have occurred with the content author or corresponding content forum area, such as a community, to determine what areas of the content are most pertinent to the reader and merit a link. The number of links created may be determined by a setting in the user profile or by a topic relevance threshold. Once the links have been constructed in the content, then the system will prioritize the links for the user so that he may go straight to the most relevant information, if desired. All data gathered for the reader profile is based upon approval from the reader. This can be as mush data as can be located or specific reader selected resources.

The system may also allow the author to impact link creation for readers by setting rules on sections of the content that may increase the relevance or decrease the relevance of a section based upon the characteristics of the reader. This will help to further personalize the content reading experience in a manner that the author desires. This may be extended to provide fine grained access control on sections of a document based on user characteristics.

The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A computer implemented method for publishing content with personalized content links, comprising:
receiving content and specified content characteristics of the content at a server;
receiving potential reader's personalization indicators at said server; and
linking said content with said specified content characteristics and said potential reader's personalization indicators; and
publishing said content at the server.

2. The computer implemented method of claim 1, wherein said specified content characteristics comprise keywords describing the content.

3. The computer implemented method of claim 1, wherein said potential reader's personalization indicators further comprise exclusionary indicators for a potential reader that should not receive said content.

4. The computer implemented method of claim 1, wherein the reader's personalization indicators comprise characteristics of readers that might be interested in the content.

5. The computer implemented method of claim 1, further comprising retrieving a personalized reader profile of the potential reader for linking with said content.

6. The computer implemented method of claim 5, wherein said personalized reader profile comprises information gathered from resources in a network relating to interests and activities of the potential reader.

7. The computer implemented method of claim 6, wherein said personalized reader profile is further augmented by information relating to the context of the environment in which said content is published.

8. The computer implemented method of claim 5, further comprising analyzing said content using said personalized reader profile to determine applicability of said content to said reader.

9. The computer implemented method of claim 8, further comprising promoting and demoting said content based upon said determined applicability.

10. The computer implemented method of claim 1 wherein said content is predefined with personalization indicators prior to receiving the content at the server.

11. A computer system for publishing content with personalized content links, comprising:
a processor programmed to:
receive content and specified content characteristics of the content;
receive potential reader's personalization indicators;
link said content with said specified content characteristics and said potential reader's personalization indicators; and
publish said content.

12. The computer system of claim 11, wherein said content characteristics comprise keywords which describe the content.

13. The computer system of claim 11, wherein said processor is further programmed to retrieve a personalized reader profile of the potential reader.

14. The computer system of claim 13, wherein said processor is further programmed to generate said personalized reader profile by gathering information relating to interests and activities of the potential reader from resources in a network.

15. A computer program product for publishing content with personalized content links, the computer program product comprising:
a computer readable storage medium having computer readable program code embodied therewith, the computer readable program code comprising:
computer readable program code configured to receive content and specified content characteristics of the content;
computer readable program code configured to receive potential reader's personalization indicators;
computer readable program code configured to link said content with said specified content characteristics and said potential reader's personalization indicators; and
computer readable program code configured to publish said content.

16. The computer program product of claim 15, further comprising computer readable program code configured to specify content characteristics by adding keywords which describe the content.

17. The computer program product of claim 15, further comprising computer readable program code configured to retrieve a personalized reader profile of the potential reader.

18. The computer program product of claim 17, further comprising computer readable program code configured to generate said personalized reader profile by gathering information relating to interests and activities of the potential reader from resources in a network based upon permission from said reader.
